(19) United States
(12) Patent Application Publication
(10) Pub. No.: US 2020/0090132 A1
(43) Pub. Date: Mar. 19, 2020

(54) COGNITIVE APPOINTMENT SCHEDULING AND MANAGEMENT INTEGRATING IoT DATA

(71) Applicant: International Business Machines Corporation, Armonk, NY (US)

(72) Inventors: Michael Bender, Rye Brook, NY (US); Gregory J. Boss, Saginaw, MI (US); Jeremy R. Fox, Georgetown, TX (US)

(21) Appl. No.: 16/133,794

(22) Filed: Sep. 18, 2018

(51) Int. Cl. G06Q 10/10; G06F 17/30; H04L 29/08

(52) U.S. Cl. CPC G06Q 10/1095; H04L 67/12; G06F 17/30702; G06F 17/30365

(57) ABSTRACT

In an approach for managing appointments a computer receives a request for an appointment from a user. The computer identifies a history data for a type of appointment, wherein the history data provides information regarding one or more prior appointments associated with the user. The computer receives IoT data prior to the scheduled appointment associated with the user. The computer determines one or more available appointments within a schedule based on the received request, the identified history data, and the received IoT data. The computer schedules an appointment based on one of the one or more determined available appointments.

### BACKGROUND

The present invention relates generally to the field of cognitive analysis, and more particularly to integrating Internet of Things (IoT) data to perform smart scheduling and management of appointments.

Cognitive analytics, or cognitive computing, applies human like intelligence to tasks through intelligent technologies such as semantics, artificial intelligence algorithms, and a number of learning techniques through which a cognitive application becomes more intelligent and more effective. Over time, cognitive analytics reveals connections, patterns, and collocations within information, through the aggregation of large amounts of data from diverse sources. Cognitive computing incorporates big data, characterized by the extreme volume, variety, and the velocity of processing, which is acquired through sources such as records, experiments, and real-time sensors used by the Internet of Things (IoT).

The IoT is a network of physical devices, vehicles, home appliances, etc. embedded with electronics, software, sensors, actuators, and connectivity which enables these objects to connect and exchange data. The physical devices are uniquely identifiable through respective embedded computing systems. However, the physical devices are able to inter-operate within the existing Internet infrastructure, through which the IoT devices are sensed and/or controlled remotely allowing the integration of the physical world to computer-based systems. A growing portion of IoT devices are created for use by consumers (e.g., vehicles, home automation, wearable technology, quantified self, connected health, appliances, etc.). The data from IoT devices may be raw or preprocessed before analytics are applied.

Appointment scheduling software allows for the management of appointments and bookings through desktop applications and/or web-based systems. Desktop applications are installed on computer hardware and maintained by employed staff, while Web-based systems include an online portal for staff and client access. Both desk-top and web-based applications serve to integrate employee and customer data, connect a calendar system to a master database, provide an ability to evaluate calendar data, and provide a permissions method.

### SUMMARY

Aspects of the present invention disclose a method, computer program product, and system for managing appointments, the method comprises one or more computer processors receiving a request for an appointment from a user. The method further comprises one or more computer processors identifying a history data for a type of appointment, wherein the history data provides information regarding one or more prior appointments associated with the user. The method further comprises one or more computer processors receiving IoT data prior to the scheduled appointment associated with the user. The method further comprises one or more computer processors determining one or more available appointments within a schedule based on the received request, the identified history data, and the received IoT data. The method further comprises one or more computer processors scheduling an appointment based on one of the one or more determined available appointments.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of an appointment scheduling program, on a proxy server computer within the data processing environment of FIG. 1, for scheduling and managing appointment times and a duration of the appointment for a client, in accordance with an embodiment of the present invention;

FIG. 3 is a flowchart depicting operational steps of an appointment tracking program, on a proxy server computer within the data processing environment of FIG. 1, for tracking and recording an actual duration of an appointment, and optimizing an appointment within a schedule in real-time in accordance with an embodiment of the present invention; and

FIG. 4 is a block diagram of components of the proxy server computer executing the appointment management program that includes the appointment scheduling program and the appointment tracking program, in accordance with an embodiment of the present invention.

### DETAILED DESCRIPTION

Appointment scheduling software allows for the management of appointments and bookings through desktop applications and/or web-based systems. Embodiments of the present invention recognize that appointments are scheduled based on traditional time slots, in which a set amount of time is allotted to perform a specific service (e.g., type of appointment, purpose of the appointment). Therefore, at the time an appointment request occurs, available appointments in the schedule reflect the time allotted for the specific service. For example, a wellness check-up at a physician's office is twenty minutes in duration, versus a half an hour appointment for a patient experiencing an ailment, or an hour-long appointment for an ultrasound. However, embodiments of the present invention recognize that while some appointments occur as scheduled (e.g., within the allocated time, begin and end as scheduled, etc.), the actual duration of an appointment varies, taking either more or less time than scheduled. Embodiments of the present invention recognize that for appointments that conclude prior to the scheduled end time, vacancies occur in the schedule (i.e., underutilization, underrun, spare time, etc.) that are not currently realized, which could be utilized for: additional appointments, additional time with another client, and/or for preparation time for the service provider. Alternatively, embodiments of the present invention recognize appointments exceeding the scheduled duration result in an unrealized overbooking condition (i.e., over utilization) that can result in various issues, such as over expenditure of time, prolonged wait times, decreased availability of appointments, diminished time available for subsequent clients, minimized preparation time between clients, and appointment rescheduling.

Embodiments of the present invention incorporate prior client history information, client pre-appointment testing information (e.g., test results), client IoT data (e.g., health monitoring data, sensor data, Global Positioning system data (GPS), etc.), and/or service provider information to manage and/or schedule appointments in advance and in real-time. By utilizing the available data, appointments reflect the actual time a client spends with a service provider rather than a standard allotted time, which improves the efficiency of the appointment scheduling system, improves interactions between the client and the service provider, prioritizes appointments, optimizes the utilization of resources, and reduces rescheduling. As embodiments of the present invention automatically adjust the appointments within the schedule based upon the information available, improvements are made to the manner in which the computing device operates. The necessity to reschedule appointments diminishes with the implementation of the invention, which reduces processing steps necessary to change an appointment.

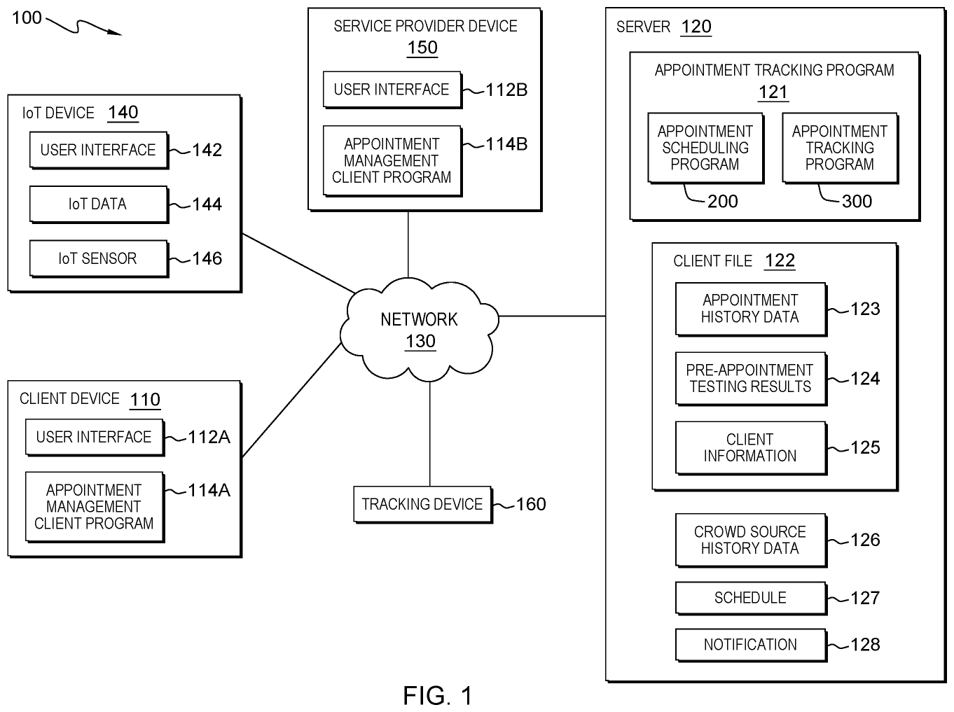

The present invention will now be described in detail with reference to the Figures. FIG. 1 is a functional block diagram illustrating a distributed data processing environment, generally designated 100, in accordance with one embodiment of the present invention. FIG. 1 provides only an illustration of one embodiment and does not imply any limitations with regard to the environments in which different embodiments may be implemented.

In the depicted embodiment, distributed data processing environment 100 includes client device 110, server 120, IoT device 140, service provider device 150, and tracking device 160, interconnected over network 130. Distributed data processing environment 100 may include additional computing devices, mobile computing devices, servers, computers, storage devices, or other devices not shown.

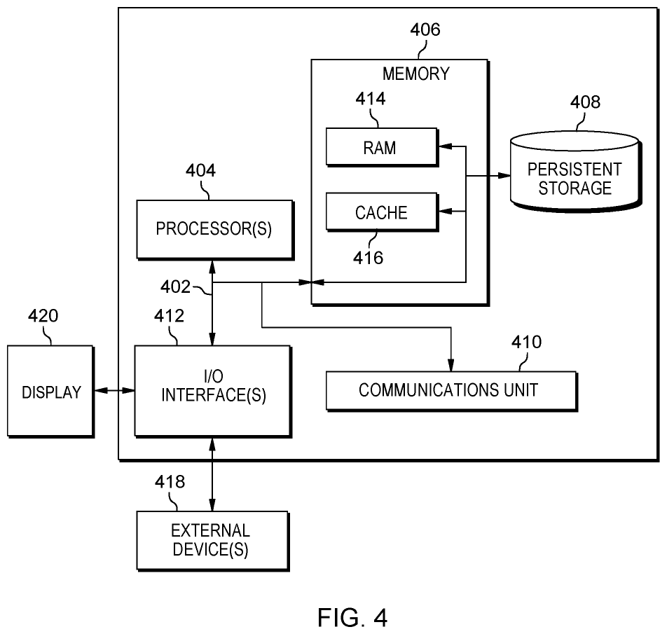

Client device 110 and service provider device 150 may be any electronic device or computing system capable of processing program instructions and receiving and sending data. In some embodiments, client device 110 and service provider device 150 may be a laptop computer, a tablet computer, a netbook computer, a personal computer (PC), a desktop computer, a personal digital assistant (PDA), a smart phone, or any programmable electronic device capable of communicating with network 130. In other embodiments, client device 110 and service provider device 150 may represent a server computing system utilizing multiple computers as a server system, such as in a cloud computing environment. In general, client device 110 and service provider device 150 are representative of any electronic device or combination of electronic devices capable of executing machine readable program instructions as described in greater detail with regard to FIG. 4, in accordance with embodiments of the present invention. Client device 110 and service provider device 150 send and receive information to appointment management program 121.

Client device 110 contains user interface 112A and appointment management client program 114A. Client device 110 is associated with a user that schedules an appointment (i.e., arrangement to meet at a particular time and place for any type of appointment that requires advance scheduling) such as but not limited to: a medical appointment, a car service appointment, a reservation at a restaurant, a personal care and grooming appointments (e.g., haircut, manicure, pedicure, massage, etc.), veterinary appointments, appointments with financial advisors, legal consultations, etc.

Service provider device 150 contains user interface 152 and appointment management client program 114B. Service provider device 150 is one or more computing devices associated with one or more individuals that work for the service provider. Through user interface 152 of service provider device 150, the individual performing and/or scheduling the appointment is able to input and receive information (e.g., length of appointment, concerns, test results, IoT data 144, manual data entry, etc.) pertaining to the client prior to, during, and after an appointment. Additionally, service provider device 150 receives input, information, and alterations (e.g., scheduling, timing changes, etc.) to appointments automatically from appointment management program 121 and/or manually from a user through appointment management client program 114B.

User interface 112A and user interface 112B are programs that provide an interface between a user and client device 110 or service provider device 150. Via user interface 112A and 112B, a plurality of applications that reside on client device 110 (e.g., appointment management client program 114A) and service provider device 150 (e.g., appointment management client program 114B) may be accessed. A user interface, such as user interface 112A and user interface 112B, refers to the information (e.g., graphic, text, sound) that a program presents to a user and the control sequences the user employs to control the program. A variety of types of user interfaces exist. In one embodiment, user interface 112A is a graphical user interface. A graphical user interface (GUI) is a type of interface that allows users to interact with peripheral devices (i.e., external computer hardware that provides input and output for a computing device, such as a keyboard and mouse) through graphical icons and visual indicators as opposed to text-based interfaces, typed command labels, or text navigation. The actions in GUIs are often performed through direct manipulation of the graphical elements. User interface 112A and user interface 112B send and receive information through appointment management client program 114A and appointment management client program 114B respectively to appointment management program 121 (i.e., appointment scheduling program 200 and appointment tracking program 300), client file 122, crowd source history data 126, schedule 127, and notifications 128.

Appointment management client program 114A and appointment management client program 114B are a set of one of more programs designed to carry out the operations for a specific application to assist a user to perform an activity (e.g., scheduling appointments in schedule 127, viewing pre-appointment testing results 124, updating client file 122, receiving notification 128, etc.). Appointment management client program 114A and appointment management client program 114B allow a user to interact, send, and receive information to and from appointment management program 121, client file 122 (i.e., appointment history data 123, pre-appointment testing results 124, and client information 125), schedule 127, and notification 128. In the depicted embodiment, appointment management client program 114A and appointment management client program 114B reside on client device 110 and service provider device 150 respectively. In another embodiment, appointment management client program 114A and appointment management client program 114B may reside on server 120 or on another device (not shown) connected over network 130.

Server 120 may be a management server, a web server, or any other electronic device or computing system capable of receiving and sending data. In some embodiments, server 120 may be a laptop computer, a tablet computer, a netbook computer, a personal computer (PC), a desktop computer, a personal digital assistant (PDA), a smart phone, or any programmable device capable of communication with client device 110, IoT Device 140, service provider device 150, and tracking device 160 over network 130. In other embodiments, server 120 may represent a server computing system utilizing multiple computers as a server system, such as in a cloud computing environment. Server 120 contains appointment management program 121, client file 122, crowd source history data 126, schedule 127, and notification 128.

Appointment management program 121 is a software program for managing appointments, bookings, reservations, and services. Appointment management program 121 integrates service providers utilizing service provider device 150 and/or clients utilizing client device 110 with associated client data from IoT device 140 (e.g., IoT data 144), tracking device 160, and files on server 120 (e.g., client file 122, crowd source history data 126, etc.) to manage the appointments within schedule 127. Appointment management program 121 includes appointment scheduling program 200 and appointment tracking program 300. In the depicted embodiment, appointment management program 121 resides on server 120. In another embodiment appointment management program 121 resides on service provider device 150 or another computing device (not shown) connected over network 130 provided client file 122, crowd source history data 126, schedule 127, and notification 128 are accessible by appointment management program 121.

Appointment scheduling program 200 is a program that schedules and adjusts a client appointment based upon an amount of time (e.g., length of time) that a service provider is anticipated to spend with the client (e.g., first client). The length of an appointment is based upon multiple factors, such as but not limited to: appointment history data 123, pre-appointment testing results 124, client information 125, crowd source history data 126, standardized appointment times (i.e., a set length of time for an appointment), service provider appointment times (i.e., service provider set the length of time of an appointment), and the appointment times relative to another client in schedule 127 (e.g., second client). In one embodiment, appointment scheduling program 200 automatically adjusts the length of time of an appointment (i.e., lengthens or shortens appointments by changing the start and/or stop times of the appointment) to minimize wait times and/or optimize schedule 127 to accommodate scheduled clients (e.g., clients that require same day appointments such as emergency appointment, drop in appointments, etc.). In another embodiment, appointment scheduling program 200 updates and/or changes the service provider to accommodate the client, while maintaining appointment times within schedule 127. For example, a service provider is part of a medical practice of two doctors, Dr. Smith and Dr. Jane. The client has an appointment to see Dr. Jane at 11 A.M. for an hour, but Dr. Jane encountered an emergency at an earlier appointment, and is behind by an hour, which would delay the client visit to 12 P.M. Dr. Smith however, has a cancelation at 11 A.M. and is able to attend to the client in lieu of Dr. Jane. Therefore, appointment scheduling program 200 updates the service provider for the client from Dr. Jane to Dr. Smith, and maintains the appointment time for the client. Additionally, appointment scheduling program 200, preserves the remainder of schedule 127, as the hour allotted to the client that was switched to Dr. Smith solves the overrun for Dr. Jane. In some other embodiments, appointment scheduling program 200 identifies an alternate date and/or time of an appointment within schedule 127 to accommodate for a change in the duration of an appointment. In the depicted embodiment, appointment scheduling program 200 resides on server 120 as a part of appointment management program 121. In another embodiment, appointment scheduling program 200 resides on server 120 as a stand-alone program. In yet another embodiment appointment scheduling program 200 resides on service provider device 150 or another computing device (not shown) connected over network 130 provided client file 122, crowd source history data 126, schedule 127, and notification 128 are accessible by appointment scheduling program 200.

Appointment tracking program 300 is a software program that tracks the amount of time that a service provider spends with a client and the overall time of an appointment in order to add information to appointment history data 123 and adjust schedule 127 in real-time. Appointment tracking program 300 receives information from tracking device 160, which provides real-time information pertaining to the client and/or the service provider. Appointment tracking program 300 calculates overruns (e.g., delays) and underruns (e.g., ahead of schedule) to perform real-time schedule adjustments to mitigate delays, shorten wait times, and add additional appointments to schedule 127. Appointment tracking program 300 reorganizes schedule 127 to absorb calculated overruns and utilize calculated underruns (e.g., adjusts lengths of appointments and/or free time provided to the service provider to make use of the unutilized time and to account for overruns). Appointment tracking program 300 sends and receives information, which includes appointment history data 123, pre-appointment testing results 124 and client information 125, schedule 127, and notifications 128, to and from appointment management client programs 114A and 114B, tracking device 160, client file 122. In the depicted embodiment, appointment tracking program 300 resides on server 120 as part of appointment management program 121. In another embodiment, appointment tracking program 300 resides on server 120 as a stand-alone program. In some other embodiments, appointment tracking program 300 may reside on client device 110, server 120, and/or on another device (not shown) connected over network 130 provided client file 122, schedule 127, and notification 128 are accessible by appointment tracking program 300.

Client file 122 includes electronic documents, data, and information pertaining to an individual client. Client file 122 includes appointment history data 123, pre-appointment testing results 124, and client information 125. Client file 122 contains information received from IoT device 140 (e.g., IoT data 144), appointment management client program 114A, and appointment management client program 114B. Appointment scheduling program 200 and appointment tracking program 300 send and receive information to and from client file 122. In the depicted embodiment, client file 122 resides on server 120. In some other embodiment, client file 122 may reside on client device 110, service provider device 150 server 120, and/or on another device (not shown) connected over network 130 provided client file 122 is accessible by appointment management client program 114A, appointment management client program 114B, IoT device 140, appointment scheduling program 200, and appointment tracking program 300. While FIG. 1 depicts a single instance of client file 122, multiple instances of client file 122 can occur (i.e., one client file corresponds to each client at a service provider and contains information unique to the individual client). For example, client file 122 may have multiple iterations each belonging to a different person or business (e.g., client file 122 A-N, where N represents any number of iterations after A.)

Appointment history data 123 includes details of prior client appointments such as the type of service scheduled, actual duration of prior appointments, history of appointment dates and time (e.g., morning, afternoon, actual duration, scheduled duration, etc.), and prior testing results (e.g., medical history information). In some embodiments, appointment history data 123 also includes trends between appointments, service provider insights, and/or a comparison between appointments (e.g., identifies difference and similarities between appointments from which conclusions are made). Appointment scheduling program 200 receives appointment history data 123 in order to select a date, time, and/or duration of an appointment within schedule 127 based on prior client appointments, which improves the efficiency of the computing system, as less searches and operator actions are necessary to create appointments for a client as the selections are tailored to the client. Appointment history data 123 stores information provided by appointment tracking program 300 and appointment scheduling program 200. Appointment tracking program 300 and appointment scheduling program 200 update appointment history data 123 with at least the duration, date, time, and type of service for scheduled appointments and for information gathered after the appointment occurs. Appointment management program 121 calculates changes between the previous appointments stored in appointment history data 123 and the most recent appointment added to appointment history data 123. In the depicted embodiment, appointment history data 123 resides on server 120. In some other embodiment, appointment history data 123 may reside on client device 110, service provider device 150 server 120, and/or on another device (not shown) connected over network 130 provided appointment history data 123 is accessible by appointment management program 121.

Pre-appointment testing results 124 include information collected pertaining to a client prior to an appointment, but after the initial appointment is scheduled. In one embodiment, pre-appointment testing results 124 include information regarding the well-being of a client, to answer a specific question, to track an ongoing condition, and/or to evaluate the success or failure of a treatment that is performed and/or collected prior to and/or leading up to an appointment. Therefore, pre-appointment testing results 124 contain results pertaining to tests performed on a patient, such as diagnosis of a condition, measuring the progression of a disease or condition, measuring the effectiveness of a treatment, and evaluating the general health of a patient. For example, pre-appointment testing results 124 include tests that are ordered in advance of an appointment (e.g., blood work, x-rays, ultra sounds, urinalysis, electrocardiogram (EKG), stress tests, bone density, etc.) by a physician, to provide a viewable result regarding specific tests that relate to the health of a client. Furthermore, pre-appointment testing results 124 may include: yes and no test results (i.e., positive or negative test results that provide a definitive answer to a question), inconclusive (i.e., results do not provide a conclusive yes or no answer) and relative value test results (i.e., results are provided as a score that is measured against a reference range or healthy range to determine health and relevance.). In another embodiment, pre-appointment testing results 124 includes IoT data 144. For example, an individual wears a heart rate monitor. As the heart rate monitor (e.g., IoT device 140) collects IoT data 144 that is pertinent to the health of the client, appointment scheduling program 200 collects and stores IoT Data 144 within pre-appointment testing results 124 for evaluation (e.g., reviews against comparison group identified within crowd source history data 126, reviews against prior recorded health data such as a fitness test, data recorded from prior instances of physical activity that the client tracked, etc.). A comparison group is a group of individuals that share demographic variables with the user, which serves as the basis for a comparison between the user and the group. The comparison provides an assessment and/or information that can be applied to the user based on the similarities. In some other embodiment, pre-appointment testing results 124 include both of the aforementioned embodiments.

In an alternative embodiment, pre-appointment test results include information pertaining to the health of systems of a vehicle that provide indications as to maintenance to be performed (e.g., emissions data, tire pressure sensor data, engine reports, vehicle computer outputs for monitored systems, etc.). In the depicted embodiment, pre-appointment testing results 124 resides on server 120. In some other embodiment, pre-appointment testing results 124 may reside on service provider device 150 and/or on another device (not shown) connected over network 130 provided pre-appointment testing results 124 is accessible by appointment management program 121.

Client information 125 includes general client information such as, but not limited to name, address, phone numbers, workplace, contact information, emergency contact information, insurance carrier, etc. that assists to uniquely identify the client. In one embodiment, client information 125 additionally includes personal client data (e.g., date of birth, medical records, medical conditions, medications, physician notes, physician requests, client preferences, preferred physician, etc.) that assists in scheduling an appointment. Additionally, client information 125 identifies IoT device 140 that the client utilizes and the access permissions for the IoT device 140. For example, the access permissions authorize the service provider to access IoT data 144 for a period of time prior to the appointment to acquire pre-appointment testing results 124. In an alternate embodiment, client information 125 includes general information for a purchased item that receives service. For example, the make, model, and year of a vehicle, measurements pertaining to tire wear, tire rotations, air filter condition, maintenance schedule, notes on future maintenance, etc. In the depicted embodiment, client information 125 resides on server 120. In some other embodiments, client information 125 may reside on service provider device 150 and/or on another device (not shown) connected over network 130 provided client information 125 is accessible by appointment management program 121.

Crowd source history data 126 is stored data obtained from a group of people that provide knowledge pertaining to appointment times (i.e., minimum, maximum, and/or average times spent at an appointment for a specified reason for an identified group of individuals). Crowd source history data 126 is a form of sanitized data in which sensitive information (e.g., protected information pertaining to a specific individual) is removed in a manner that prevents the identity of the user providing the information from being identified later. For example, crowd source history data 126 contains information regarding the average amount of time spent at a type of appointment. Appointment scheduling program 200 receives appointment length times (i.e., duration) as sanitized data from crowd source history data 126. In the depicted embodiment, appointment crowd source history data 126 resides on server 120. In another embodiment, crowd source history data 126 may reside on service provider device 150 and/or on another device (not shown) connected over network 130 provided crowd source history data 126 is accessible by appointment management program 121.

Schedule 127 is a time-table (e.g., time-management tool, calendar, appointment book, etc.) that includes a list of times at which possible tasks, events, actions, future arrangements, or meetings are intended to take place. Schedule 127 is created through a scheduling process in which available time slots are filled with appointments for a client to perform a specific service. In one embodiment, appointment scheduling program 200 initially creates schedule 127 through recommendations based on appointment history data 123, a series of user actions by a user of client device 110, a user of service provider device 150, or any combination of the three. In another embodiment, appointment scheduling program 200 automatically updates schedule 127 based on an analysis of pre-appointment testing results 124 and/or information provided by appointment tracking program 300 (e.g., provides real-time underruns or overruns that occur within schedule 127). In the depicted embodiment, schedule 127 resides on server 120. In another embodiment, schedule 127 may reside on client device 110, service provider device 150, and/or on another device (not shown) connected over network 130 provided schedule 127 is accessible by appointment management program 121.

Notification 128 is a message that is automatically generated and sent to client device 110 and/or service provider device 150 by appointment management program 121 based on changes to schedule 127. For example, based on pre-appointment testing results 124, appointment scheduling program 200 extends the length of a client appointment, and sends notification 128 to the client for notification and/or confirmation of the extension within schedule 127. Additionally, appointment scheduling program 200 notifies the service provider of the extension and may include additional details pertaining to the reason for the time extension. In another example, appointment tracking program 300 provides notification 128 to a service provider to indicate that the service provider is running behind, and issues warnings to motivate the service provider to maintain schedule 127. Additionally, if appointment tracking program 300 changes schedule 127, appointment tracking program 300 notifies the user of client device 110 of the changes (e.g., availability of earlier start time on an appointment, delay to the start of an appointment, notification of change of service provider, etc.). In the depicted embodiment, notification 128 resides on server 120 (e.g., appointment management program 121 creates notification 128 and can store notification 128 for verification, resending, tracking, etc.). In another embodiment, notification 128 may reside on service provider device 150, and/or on another device (not shown) connected over network 130 provided schedule 127 is accessible by appointment scheduling program 200 and appointment tracking program 300.

Network 130 may be a local area network (LAN), a wide area network (WAN) such as the Internet, a wireless local area network (WLAN), any combination thereof, or any combination of connections and protocols that will support communications between client device 110, server 120, IoT device 140, service provider device 150, tracking device 160 and other computing devices and servers (not shown), in accordance with embodiments of the inventions. Network 130 may include wired, wireless, or fiber optic connections.

Internet of Things (IoT) device 140 are objects that can be assigned an Internet Protocol (IP) address and include the ability to connect, transmit, exchange, and transfer IoT data 144 over network 130. IoT device 140 includes physical devices, wearable devices, implantable technology, vehicles sensors (e.g., safety and security, powertrain/fuel economy, infotainment, and telematics), home sensors (e.g., energy efficiency, home environment monitoring, resident well-being, smart homes, smart thermostats), home appliances (e.g., smart appliances, smart TV, etc.), and other non-standard computing devices that are embedded with electronics, software, sensors, actuators, and connectivity. IoT device 140 collect IoT data 144 via sensors and communicate IoT data 144 to a user of IoT device 140, additional users of another instance of IoT device 140 that are connected to the user of IoT device 140 (e.g., friends connected through application software that share data collected on individual instances of IoT device 140 for each friend), and/or entities that track and/or utilize IoT data 144. While FIG. 1 depicts a single instance of IoT device 140, multiple instances of IoT device 140 can occur (i.e., a client utilizes more than one IoT device 140). For example, IoT device 140 may have multiple iterations each belonging to a different device worn by the client (e.g., IoT device 140 A-N, where N represents any number of iterations after A.)

In some embodiments, IoT device 140 that are wearable devices, refer to electronic technologies or computers that are incorporated into clothing and accessories (e.g., activity trackers, smart watches, pedometers, sleep apnea detector, heart rate monitor, watches, glasses, contact lenses, e-textiles and smart fabrics, jewelry, etc.). Some wearable devices perform health monitoring of vital signs such as heart rate, heart rate recovery, heart rate variability, VO₂ max, minute ventilation, respiration rate, breathing efficiency, body temperature, blood pressure, blood glucose levels, insulin delivery, activity, posture, cadence, bounce, braking, pelvic rotation, pelvic drop, muscle activity, activity level, acceleration, calories, steps, fatigue levels, workout effort, emotional wellness, muscle tension, sleep, and any other measurable vital signs. Smart clothes (e.g., electronic textiles, smart garments, smart textiles, smart fabrics, etc.) include fabric that envelopes traditional sensor electronics, and fabric in which the weaving incorporates electrically conductive yarn into the fabric to obtain a textile that connects multiple sensors to the body of the wearer for health monitoring of vital signs (e.g., heart rate, temperature, activity, and posture). For example, smart socks include: pressure sensors that identify the striking of the heel or the ball of wearers foot when walking, a foot heat-map, foot landing, contact time on the ground, cadence, pace, heart rate, speed, distance, altitude gains, GPS track, etc., which can provide a podiatrist with information to treat a client experiencing issues related to the foot, ankle, and structures of the leg.

In some embodiments, IoT device 140 that are a form of implantable technology, are miniaturized devices that includes a power source that may be placed inside the human body surgically (e.g., pacemaker, diabetic monitoring device, heart monitoring implants, biochip transponders, devices for environmental/food/pathogen monitoring, remote patient monitoring device, etc.). In another embodiment, IoT device 140 include technology that can be swallowed such as a smart pill, which is a single-use, ingestible capsule that monitors pressure, acid level (e.g., pH), and temperature through your entire GI tract. In another embodiment IoT device 140 include smart tattoos which are imbedded flat, flexible, stretchable electronic sensors designed into temporary tattoos that can withstand wrinkling, bending, and twisting of the skin that monitor electric signals produced by the heart, brain, and muscles. Additional detectors, transmitters and receivers, and biosensor technology can also be included in the smart tattoo to monitor blood oxygen levels (i.e., pulse oximetry), and to incorporate a basic stethoscope, thermometer, and blood pressure cuff. IoT device 140 sends IoT data 144 to one or more of client device 110, service provider device 150, and server 120 within client file 122 (e.g., specific to a user).

User interface 142 is a program that provides an interface between a user of IoT device 140 and a plurality of functions that reside on client device 110 (e.g., heart rate monitoring, physical activity tracking, diabetic monitoring, blood pressure monitoring, global positioning system location, vehicle sensor monitoring, and/or other IoT device 140 specific tracking and monitoring function) and/or may be accessed over network 130 by a user of client device 110, a user of service provider device 150, appointment management program 121, server 120, and a plurality of applications that reside on client device 110, service provider device 150, and server 120. In one embodiment, IoT device 140 transfers IoT data 144 over network 130 to client device 110 and to server 120, from which greater details may be viewed and additional information can be gathered (e.g., individual and/or service provider views the individual's health statistics, health monitoring services gather crowd source history data 126). In one embodiment, user interface 142 sends IoT data 144 to appointment management client program 114A. In another embodiment, user interface 142 sends IoT data 144 directly to client file 122 for utilization by appointment management program 121. In some other embodiment, user interface 142 sends IoT data 144 to a computing device (not shown) for processing by specialized computing software and/or a subject matter expert, prior to sending to server 120 for inclusion in pre-appointment testing results 124.

IoT data 144 is the facts and statistics collected for reference and/or analysis by IoT sensor 146 that pertain to a user and/or device from which knowledge is derived. IoT data 144 includes data measured and collected from the physical world via sensors, which results in a change of states of output and actuators within IoT device 140 that are reported and analyzed. IoT device 140 shares sensor data, collected via IoT sensor 146, through an IoT gateway (i.e., a physical device or software program that serves as a connection point between the cloud and controllers, sensors and intelligent devices) or another edge device (i.e., a device that provides an entry point into enterprise or service provider core networks such as routers, routing switches, integrated access devices, wide area networks, etc.). In one embodiment, IoT sensor data 146 is sent to the cloud for analysis or analyzed locally and results in IoT data 144. In another embodiment, IoT data 144 is data collected from IoT device 140 as unprocessed raw data or minimally processed data that is downloadable for further processing and analysis. In one embodiment, IoT data 144 includes health monitoring data (e.g., blood pressure, heart rate, blood glucose levels, temperature, data specific to the designed function of IoT device 140 etc.). In another embodiment, IoT data 144 includes sensor data pertaining to a machine (e.g., vehicle sensors that monitor emissions, oxygen levels, cabin temperature, vehicle telematics). Additionally, in some embodiments, IoT data 144 also includes GPS tracking information that tracks the movement of an individual and/or machine. In the depicted embodiment, IoT data 144 resides on IoT device 140. In another embodiment, IoT data 144 may reside on client device 110, server 120, and/or on another device (not shown) connected over network 130.

IoT sensor 146 is a sensor, module, or subsystem that detects events or changes to an environment. IoT sensor 146 detects information specific to IoT device 140 (i.e., sensor installed in IoT device 140 is specific to the type and/or purpose of IoT device 140). For example, IoT device 140 is a heart monitoring implant, and therefore, records data pertaining to the heart of the individual in which IoT device 140 is installed. In another example, IoT sensor 146 is a green light emitting diode (LED) paired with light sensitive photodiodes to detect the amount of blood flow in the wrist of the wearer, and detects a heartbeat upon a greater absorption of green light. In another example, IoT device 140 is a built-in sensor within a vehicle, and therefore, collects data specific to the vehicle (e.g., emissions, cabin temperature, vehicle telematics, etc.). IoT sensor 146 can send detected information (e.g., IoT data 144) to user interface 114C, client device 110, server 120, and additional computing devices (not shown) over network 130 for display and analysis (e.g., user of IoT device 140, appointment management program 121, pre-appointment testing results 124, etc.).

Tracking device 160 is a device that determines the location of an individual (e.g., user and/or service provider). In one embodiment, tracking device 160 determines the locations of the client and the service provider at the location of the service provider (e.g., tracks movement of the client and service providers within the offices of the service provider). In another embodiment, tracking device 160 determines the location of a client that is in route to the service provider (e.g., tracks a client driving to an appointment to determine a time or arrival at the service provider). Appointment tracking program 300 utilizes tracking device 160 to determine the amount of time a client actually spends with a service provider. Additionally, appointment tracking program 300 utilizes the information from tracking device 160 to track the location of a client in order to determine adjustments to schedule 127 (e.g., moves an appointment forward in time, moves an appointment backward in time, maintains appointment scheduled time, adds a new client, rearranges the order of appointments, etc.) to avoid unnecessary delays and to maximize the schedule to accommodate clients and/or service providers.

In one embodiment, tracking device 160 is a global positioning system device that provides geolocation and time information. In another embodiment, tracking device 160 is a near field communication device (i.e., set of communication protocols that enable two electronic devices to establish communication). For example, a near field communication (NFC) device can act as an electronic identity document and/or keycard that is read by a card reader to identify and track the movement of an individual within a building. In some other embodiments, tracking device 160 is a radio-frequency identification (RFID). The RFID utilizes electromagnetic field to automatically identify and track tags attached to objects. In yet some other embodiments, tracking device 160 is an access badge that is a credential for gaining entry to an area with access control points controlled by a card reader. The access badge includes technologies such as a magnetic stripe (i.e., stores data by modifying the magnetism of a band of magnetic material on the card), proximity (i.e., contactless smart card with embedded integrated circuits), bar code (i.e., optical, machine readable representation of data), smart cards (i.e., pocket sized card with embedded integrated circuits), and or biometric devices (i.e., recognize physiological or behavioral characteristics such as fingerprints, facial images, iris prints, voice recognition, etc.). The access badge is read by a device reader, which grants the holder access based upon verifying the credentials with an access control list and logs the entry/exit times.

In the depicted embodiment, tracking device 160 is a stand-alone device. In another embodiment, an instance of tracking device 160 resides in one or more of: client device 110, IoT device 140, service provider device 150, or another computing device (not shown.). While only one tracking device is depicted, multiple instances of tracking device 160 may be utilized. For example, client device 110, IoT device 140, and service provider device 150 each include an instance of tracking device 160, and therefore, provide individual location and time information. However, the location and time data from client device 110 and IoT device 140 is specific to the user, whereas the location data from service provider device 150 is specific to the service provider. In an example in which multiple service providers are present, each service provider is associated with a specific identification that uniquely distinguishes each service provider and the location of each service provider from the other service providers within an office.

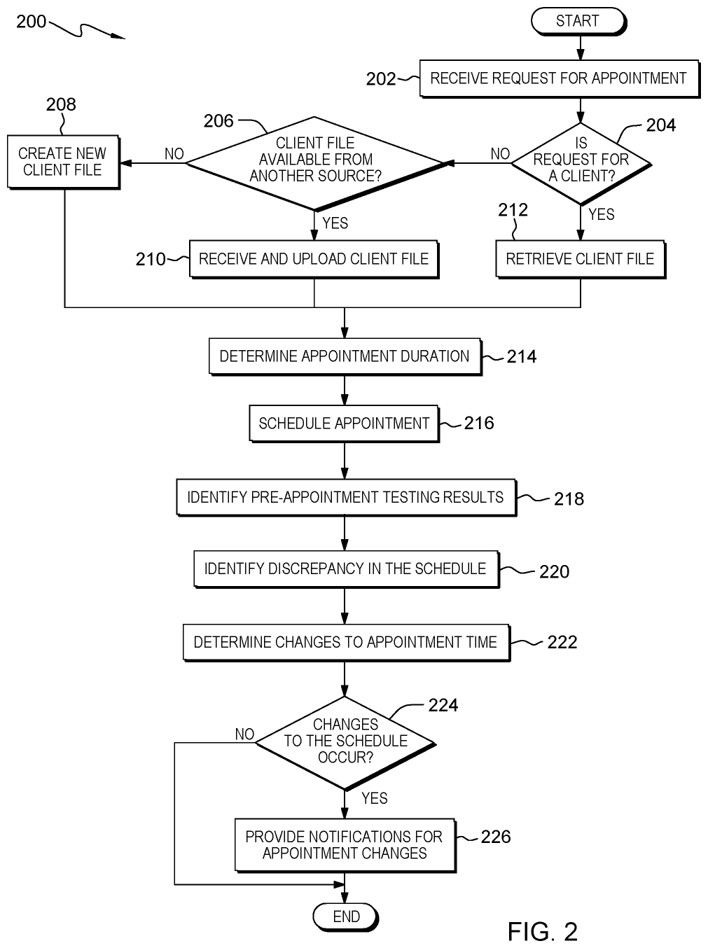

FIG. 2 is a flowchart depicting operational steps of appointment scheduling program 200 for scheduling and managing appointment times, which is capable of customizing and altering a duration of an appointment for a client within schedule 127, in accordance with an embodiment of the present invention. In one embodiment, appointment scheduling program 200 initiates as a background program and/or a function of an appointment scheduling application. In another embodiment, appointment scheduling program 200 is a stand-alone program for scheduling appointments. In some other embodiment, appointment scheduling program 200 initiates in response to a client or service provider request to create an appointment. In yet another embodiment, appointment scheduling program 200 is a program that initiates in response to a user request to optimize schedule 127. In yet some other embodiments, appointment scheduling program 200 automatically initiates upon identifying pre-appointment testing results 124 (step 218) or identifying a discrepancy (step 220). For example, a client schedules an appointment two months in advance, at which time appointment scheduling program 200 determines that pre-appointment testing results 124 are not present. However, the physician orders bloodwork for a client to be performed one week prior to the appointment. The client schedules a blood draw the Monday prior to the scheduled appointment, and the laboratory performs the ordered bloodwork. Appointment scheduling program 200 receives the bloodwork results on Wednesday from the laboratory, and appointment scheduling program 200 initiates in response to receipt of the bloodwork results for the indicated client. In some other embodiment, appointment scheduling program 200 initiates in response to a request to update appointments based on receipt of information from appointment tracking program 300 (yes branch of decision 308 or decision 316).

In step 202, appointment scheduling program 200 receives a request for an appointment. In one embodiment, appointment scheduling program 200 receives a client request to create an appointment within schedule 127. For example, a client accesses a client portal and selects to schedule a new appointment, which automatically initiates appointment scheduling program 200. In some other embodiments, appointment scheduling program 200 receives a request for an appointment from appointment management client program 114B from a service provider. For example, a client calls the service provider to schedule the appointment, and the service provider accesses schedule 127 via appointment management client program 114B. In one embodiment, appointment scheduling program 200 provides an online appointment request form to the user for completion. In another embodiment, appointment scheduling program 200 provides a computer guided questionnaire to acquire information, which also alters the questionnaire based on client responses. For example, appointment scheduling program 200 asks whether the client has allergies. If the client responds “no” to allergies, then appointment scheduling program 200 moves to the next question. However, if the client responds “yes” to allergies, then appointment scheduling program 200 asks for a list of allergies. In one embodiment, appointment scheduling program 200 receives the client and request information upon submission of the form or completion of the guided questionnaire. In another embodiment, appointment scheduling program 200 receives the client information and request information as a service provider enters the information. In some other embodiments, appointment scheduling program 200 receives the client information and request information as the client completes each question of the self-guided questionnaire.

In decision 204, appointment scheduling program 200 determines whether the request is for a client. In one embodiment, appointment scheduling program 200 determines whether the request is for a client based on information within the request form or questionnaire. For example, the form or questionnaire asks the requestor to identify as a client or a new client. Appointment scheduling program 200 identifies the field within the form or questionnaire that pertains to the new or existing client question. Appointment scheduling program 200 retrieves the answer from the corresponding input field, and determines whether the client is a new or existing client based on the provided answer. In another embodiment, appointment scheduling program 200 determines whether the requestor is for a client by searching a client database (e.g., database of past clients, stored as instances of client file 122) based on one or more client identifiers (e.g., name, address, phone number, e-mail address, client id number, etc.) for a match based on the information provided within the request for an appointment. If appointment scheduling program 200 identifies an instance of client file 122 that matches the client identifiers within the request, then appointment scheduling program 200 determines the requestor is a client. Conversely, if appointment scheduling program 200 does not identify an instance of client file 122 that matches the client identifiers within the request, then appointment scheduling program 200 determines the requestor is a new client. In some other embodiment, appointment scheduling program 200 determines the requestor is a client, through login information (e.g., the requestor has a login id and password credentials that identify the requestor as a client). For example, appointment scheduling program 200 provides the requestor an option to log into an existing account or create a new account. If the requestor logs into an existing account, then appointment scheduling program 200 determines the requestor is a client based on the presence of a user account. If the requestor selects to create an account, then appointment scheduling program 200 determines the requestor is a new client.

If appointment scheduling program 200 determines the request is for a client (decision 204, yes branch), then appointment scheduling program 200 retrieves client file 122 (step 212). If appointment scheduling program 200 determines the request is not for a client (decision 204, no branch), then appointment scheduling program 200 determines whether client file 122 is available from another source (decision 206).

In decision 206, appointment scheduling program 200 determines whether client file 122 is available from another source. In one embodiment, appointment scheduling program 200, through an appointment request form or questionnaire, includes additional questions for new clients to identify another service provider as a source of client file 122 and to complete a release form (e.g., transfer records). For example, a client moves from Orlando, Fla. to New York City, N.Y. The client schedules a first dental cleaning in New York City, and therefore, identifies the dental practice the client attended in Orlando as a source of client file 122. The client completes release forms which allows the dental practice in Orlando to send prior dental history and X-rays to the new dental practice in New York City for utilization. If appointment scheduling program 200 determines the appointment request form indicates that prior history is not available from another service provider, then appointment scheduling program treats the client as a new client.

In another embodiment, appointment scheduling program 200 searches a private database for an instance of client file 122 that matches provided client information (e.g., name, address, phone number, insurance ID number, etc.). A private database is a database that is restricted to the use of a particular person, group, and/or class (e.g., closed database includes sensitive and/or protected information that is controlled by security features, which grant access to authorized personnel). Sensitive or protected information is personally identifiable information that can be traced to an individual that if disclosed can result in harm to the person (e.g., biometric data, medical information, financial information, passports social security numbers, etc.). Appointment scheduling program 200 determines whether the client submits a completed release form. If appointment scheduling program 200 determines the client submits a completed release form, then appointment scheduling program 200 determines client file 122 is available from another source. If appointment scheduling program 200 determines the client does not submit a completed release form, then appointment scheduling program 200 determines client file 122 is not available from another source, and handles the client as a new client (decision 206, no branch).

If appointment scheduling program 200 determines client file 122 is available from another source (decision 206, yes branch), then appointment scheduling program 200 receives and uploads client file 122 (step 210). If appointment scheduling program 200 determines client file 122 is not available from another source (decision 206, no branch), then appointment scheduling program 200 creates a new instance of client file 122 (step 208).

In step 208, appointment scheduling program 200, creates a new instance of client file 122. In one embodiment, appointment scheduling program 200 automatically creates client file 122 based on the request form and/or questionnaire. In another embodiment, appointment scheduling program 200 creates a preliminary instance of client file 122 that requires client review and approval of the automatically entered information in order to create client file 122. In some other embodiment, appointment scheduling program 200 creates client file 122 in response to a service provider manually entering at least basic information to client file 122.

In step 210, appointment scheduling program 200 receives and uploads client file 122 from another source. Appointment scheduling program 200 sends a request for client file 122 with release forms to another service provider. Appointment scheduling program 200 receives client file 122 from the another service provider. Appointment scheduling program 200 uploads and saves client file 122 locally in a database of the service provider for utilization (e.g., accesses history to make determination regarding services, health, and care, provides appointment duration times, and allows for the updating of client file 122 with new information).

In step 212, appointment scheduling program 200 retrieves client file 122. Appointment scheduling program 200 accesses a database of client information for the service provider (e.g., privately stored records of client file 122 that the service provider maintains, stores and updates regarding clients that utilize the services of the service provider) and identifies the corresponding instance of client file 122 for the client. In one embodiment, appointment scheduling program 200 automatically identifies and retrieves client file 122 based on the determination that the requestor is a client (decision 204, yes branch). In another embodiment, appointment scheduling program 200 retrieves client file 122 through a series of service provider-initiated actions. In some other embodiment, appointment scheduling program 200 retrieves client file 122 through a combination of automatic and service provider actions. For example, appointment scheduling program 200 automatically searches the client database for corresponding client information and displays possible clients to the service provider for final selection.

In step 214, appointment scheduling program 200 determines an appointment duration. Appointment scheduling program 200 accesses appointment history data 123 within client file 122 to assist in the determination of an appointment duration. In one embodiment, appointment scheduling program 200 determines that appointment history data 123 is empty (e.g., new client). Therefore, appointment scheduling program 200 determines appointment durations based on standard allotted appointment times and/or on crowd source history data 126. Appointment scheduling program 200 retrieves information from crowd source history data 126 that matches demographic information (e.g., race, gender, age, etc.), risk factors (e.g., medical history, past diseases, injuries, treatments, medical conditions, additional medical factors, etc.), type of appointment (e.g., reason for an appointment such as physical, screening, vaccination, ultrasound, x-ray, dental cleaning, eye exam, etc.) and/or practitioner type (e.g., dermatologist, allergist, optometrist, dentist, general practitioner, medical specialist, etc.) for a client (i.e., creates a comparison group). For example, a client is a 23-year-old male. Appointment scheduling program 200 searches crowd source history data 126 for a comparison group (e.g., group of individuals that share attributes, demographics, risk factors, conditions, etc., with the client, such as males between the ages of 20 and 25). Appointment scheduling program 200 analyzes the comparison group for the type of appointment requested and determines an average appointment duration.

In another embodiment, appointment scheduling program 200 averages the actual time duration of prior appointments within appointment history data 123 to determine the duration of the appointment to schedule. For example, the last three appointments within appointment history data are 18 minutes, 25 minutes and 21 minutes, which appointment scheduling program 200 calculates the overall average time to be 21 minutes. Utilizing rounding and the contingency buffer with the averaged time of 21 minutes, appointment scheduling program 200 selects a duration time of 20 minutes for the appointment. In some other embodiment, appointment scheduling program 200 determines an appointment duration based on trends within appointment history data 123. For example, for the last three appointments, each appointment has been 5 minutes longer than the prior appointment (e.g., 30 minutes, 35 minutes, and 40 minutes). Appointment scheduling program 200 selects an initial appointment duration of 40 minutes, however, appointment scheduling program 200 predicts a time overrun of 5 minutes for a 45-minute appointment. In another example, a parent has two children. Each time the parent schedules a single appointment for a sick child, the parent also brings the second child to the appointment. The physician while looking at the sick child, also examines the second child which extends the length of the appointment. Therefore, appointment scheduling program 200 determines an appointment duration to accommodate the examination of a second child even if the second child is not identified at the time the appointment is made. In yet another embodiment, appointment scheduling program 200 determines an appointment duration based on appointment history data 123 for a type of appointment. For example, a client calls to schedule a yearly physical. Appointment history data 123 includes appointment durations for yearly physicals, illness visits, and immunization/vaccination appointments. Appointment scheduling program 200 determines the duration based solely on the data associated with the yearly physicals.

In yet another embodiment, appointment scheduling program 200 determines the duration of the appointment based on notes provided by the service provider within appointment history data 123. For example, an individual usually talks very little with two of the three doctors within a practice. However, while the individual talks with the third doctor, the discussion are not related to medical issues, as identified by notes entered by the doctor within appointment history data 123 that summarize prior appointments. Appointment scheduling program 200 analyzes appointment history data 123 and determines that the actual appointment takes five minutes less than other patients with the first two doctors, whereas the third doctor requires ten additional minutes. As the overrun is due to the discussion of non-medical issues, appointment scheduling program 200 maintains the appointment duration, but suggests scheduling the client with one of the first two doctors, or sets a reminder for the third doctor within schedule 127 regarding the client's habit, so that the third doctor can respond accordingly to remain on schedule.

In yet some other embodiment, appointment scheduling program 200 determines the duration of an appointment based on appointment history data 123, client information 125, and the type of appointment. For example, a client calls to schedule a yearly physical. Appointment scheduling program 200 determines that the client turned 50 based on client information 125. Appointment scheduling program 200 determines that a yearly physical for a 50-year-old includes additional testing that was not performed previously. Appointment scheduling program 200 determines the duration of prior yearly physicals to be 25 minutes (e.g., five minutes less than the standard half hour). Additionally, appointment scheduling program 200 retrieves the standard time for a 50-year-old yearly physical of 45 minutes from crowd source history data 126. Appointment scheduling program 200 determines the difference between the standard times for the two appointments, and determines a 15-minute time difference (e.g., increase of 15 minutes in duration). Appointment scheduling program 200 calculates the duration of the appointment by combining the standard time difference (e.g., 15 minutes) with the historical time duration (e.g., 25 minutes). Therefore, appointment scheduling program 200 calculates the durations of the appointment to be 40 minutes. In other alternate embodiments, appointment scheduling program 200 utilizes one or more of the aforementioned embodiments to determine the duration of an appointment

In step 216, appointment scheduling program 200 schedules an appointment within schedule 127. Appointment scheduling program 200 identifies available appointment times based on the determined duration of the appointment. In another embodiment, appointment scheduling program 200 identifies available appointment times based on the determined duration of the appointment and/or for predicted overruns and underruns. For example, appointment scheduling program 200 determines an appointment will take approximately 40 minutes. However, appointment scheduling program 200 also predicts a ten-minute overrun based on appointment history data 123. Therefore, appointment scheduling program 200 identifies appointments within schedule 127 for available appointment times that are able to accommodate the predicted ten-minute overrun (e.g., prior to a lunch break, last appointment of the day, prior to a preparation time block, prior to a catch-up period, before an appointment that historically starts late, after an appointment that historically ends early, etc.). Furthermore, in some embodiments, appointment scheduling program 200 performs a risk impact analysis of predictions associated with other clients to identify an appointment time in schedule 127. A risk impact analysis is a process of assessing the probabilities and consequences of risk event if the risk event occurs. For example, a 40-minute appointment is available within schedule 127 from 9:45 A.M. to 10:25 A.M. A first client scheduled from 9:10 A.M. to 9:40 A.M. has an average appointment duration of 27 minutes, and a second client scheduled at 10:30 A.M., based on appointment history data 123, arrives 10 minutes late (e.g., 10:40 A.M.) but ends the appointment on time. The requestor arrives on average 15 minutes early but exceeds the appointment time by five minutes. Appointment scheduling program 200 determines the requestor will be able to enter the appointment early (e.g., 9:42 A.M. or earlier) and will finish no later than 10:27 A.M., with a minimal risk impact to schedule 127 (e.g., best case the physician has 13 extra minutes to utilize with the prior patient and/or in preparation and worst case the physician will lose a five-minute preparation period.

In another embodiment, appointment scheduling program 200 identifies an appointment within schedule 127 based on a first available appointment that matches the determined time duration. In another embodiment, appointment scheduling program 200 identifies appointments based on the determined duration and client preferences (e.g., time of day, day of week, insurance criteria) within appointment history data 123. In some other embodiment, appointment scheduling program 200 identifies an appointment within schedule 127 based on one or more of the aforementioned embodiments. In one embodiment, appointment scheduling program 200 automatically selects an appointment date and time, and provides the appointment to the client and/or service provider for confirmation. In another embodiment, appointment scheduling program 200 provides a list of matching available appointment times for selection and confirmation by the client and/or service provider (e.g., confirms a selection based on client response). Appointment scheduling program 200 receives selection and confirmation of an appointment time from a client and/or service provider, and schedules the selected appointment in schedule 127.

In step 218, appointment scheduling program 200 identifies pre-appointment testing results 124. In one embodiment, appointment scheduling program 200 determines that the client authorized access and collection of IoT data 144 from IoT device 140 based on client information 125. For example, at the time the client schedules the appointment, the client identifies a personal wearable instance of IoT device 140. The service provider requests access to IoT device 140 and IoT data 144, for the day of and/or days prior to an appointment for collection and analysis (i.e., creates pre-appointment testing results 124). Appointment scheduling program 200 collects pre-appointment testing results 124 (e.g., IoT data 144) for the authorized time period. In another embodiment, appointment scheduling program 200 determines the service provider scheduled testing via a specialized instance of IoT device 140 (e.g., pill cam, pacemaker, diabetic monitoring system, etc.), and collects IoT data 144 based on a start time and a selected monitoring time period. In another embodiment, appointment scheduling program 200 determines that the service provider ordered pre-appointment testing (e.g., blood work, EKG, ultrasound, urinalysis, etc.) to be performed by another service provider (e.g., hematology, radiology, pathology, etc.). Appointment scheduling program 200 receives an electronic notification upon completion of the pre-appointment testing that client file 122 includes pre-appointment testing results 124 (e.g., lab report detailing results, x-rays, etc.). Conversely, in an embodiment, appointment scheduling program 200 determines that pre-appointment testing results 124 are not included for instances in which the client does not own an instance of IoT device 140, does not authorize access to IoT device 140, and/or the service provider does not request and/or schedule pre-appointment testing to be performed.

In step 220, appointment scheduling program 200 identifies a discrepancy in schedule 127 due to another appointment. A discrepancy is a difference (e.g., variation, conflict, inconsistency, deviation, change, etc.) within schedule 127 that results due to a time change associated with another appointment. (e.g., change in duration of a previously scheduled appointment). The occurrence of a discrepancy can result in an overrun or underrun of a subsequent scheduled appointment, which depending on the magnitude of the discrepancy, can cascade through multiple subsequent appointments that follow the discrepancy. In one embodiment, appointment scheduling program 200 does not identify a discrepancy. In another embodiment, appointment scheduling program 200 detects manual and/or automatic time changes to the duration of an appointment within schedule 127. Appointment scheduling program 200 automatically identifies the source of the discrepancy (e.g., appointment that incurs the change). Appointment scheduling program 200 generates a service request in response to the identified discrepancy to verify remaining appointment times that occur after the discrepancy for further impacts to appointments within schedule 127.

In step 222, appointment scheduling program 200, determines changes to appointment times. In one embodiment, appointment scheduling program 200 determines changes to the appointment time based on a discrepancy (e.g., time changes for another appointment, which impacts subsequent appointments). Appointment scheduling program 200 evaluates the discrepancy with respect to the time allowed for the appointment, and/or with respect to additional available time that surrounds the appointment (e.g., preparation periods, record upkeep, office work, off-duty, on-call, predicted underruns, and predicted overruns, etc.). In one embodiment, appointment scheduling program 200 determines the time change of the discrepancy exceeds the allowed and/or available time associated with the scheduled appointment. Appointment scheduling program 200 calculates the magnitude of the overrun (i.e., size of a delay that the subsequent appointment incurs due to the overlap caused by the overrun of the first appointment). Appointment scheduling program 200 further determines whether the appointment time changes for the client by determining whether the magnitude of the overrun from a prior appointment exceeds a threshold value of an allowable overrun between appointments (e.g., negligible delay, less than a ten-minute delay to the start of an appointment, absorbed within a contingency buffer, etc.).

For example, appointment scheduling program 200 determines a five-minute overlap between a first and second appointment due to a time duration change of the first appointment of ten minutes (e.g., five-minute delayed start of the second appointment). Appointment scheduling program 200 determines the magnitude of the overrun is less than the threshold. Additionally, appointment scheduling program 200 determines appointments in schedule 127 include a five-minute time contingency buffer to account for variations in appointment durations (e.g., five minutes of the ten-minute delay are accounted for by the contingency buffer of the first appointment). Therefore, appointment scheduling program 200 determines that the second appointment is capable of absorbing the remaining five minutes overrun within the contingency buffer for the second appointment, thereby placing schedule 127 back on time without changing schedule 127. Conversely, appointment scheduling program 200 determines a twenty-minute delay to the start of the second appointment, which exceeds the overrun threshold, and therefore, appointment scheduling program 200 determines the overrun results in changes to future appointments within schedule 127.

In another embodiment, appointment scheduling program 200 determines an underrun between appointments (e.g., unscheduled time in schedule 127). Appointment scheduling program 200 calculates the magnitude of the underrun (i.e., time difference between the end of the appointment that incurs a time change and the start of the subsequent appointment. Appointment scheduling program 200 determines whether the magnitude of the time change is sufficient to add an additional appointment (e.g., compares the magnitude of the time change to a minimum appointment time). If appointment scheduling program 200 determines the magnitude of the change is at least equal to the minimum appointment time, then appointment scheduling program 200 adds a new appointment time. If appointment scheduling program 200 determines the magnitude of the change is less than the minimum appointment time, then appointment scheduling program 200 utilizes the underrun for one or more of the following: utilization by the service provider (e.g., a break, a preparation period, office paper work, etc.), and/or moves subsequent client appointments to earlier appointment times, which may result in changes to schedule 127.

In another embodiment, appointment scheduling program 200 determines changes to the appointment time based on pre-appointment testing results 124. In one embodiment, appointment scheduling program 200 compares pre-appointment testing results 124 with appointment history data 123 (e.g., prior history of testing results) to determine variations between pre-appointment testing results 124 and historical testing results. Appointment scheduling program 200 determines whether the variations are within tolerance levels (e.g., tolerances are based on medial standard normal ranges, relative value test results, results flagged for review, and/or baseline results of the client set as normal with set tolerance ranges). If appointment scheduling program 200 determines the variations are within the tolerance levels, then appointment scheduling program 200 determines that the appointment time does not change. However, if appointment scheduling program 200 determines the variations are outside the tolerance levels, then appointment scheduling program 200 determines changes to the appointment time based on times set by the service provider to discuss variations, standard times set to discuss results, and/or by manual adjustment by the service provider (e.g., results are flagged for review by physician, and upon review, the physician alters the appointment time).

In another embodiment, appointment scheduling program 200 analyzes pre-appointment testing results 124 based on the reported information (i.e., an analysis of pre-appointment testing results 124 provided by the service provider that performs pre-appointment testing, subject matter expert and/or review by the service provider). For example, pre-appointment testing results 124 are results for blood work ordered by the physician that include relative value assessments and yes or no results for medical conditions. Appointment scheduling program 200 determines whether pre-appointment testing results 124 include results that are outside of normal ranges, abnormal, inconclusive results, and/or positive for medical conditions. In another example, pre-appointment testing results 124 include IoT data 144, collected from a heart rate monitor (e.g., IoT device 140). The service provider reviews IoT data 144 and identifies a higher heart rate and longer recovery times during periods of activity, which may indicate a developing health problem that should be discussed and/or evaluated, and thus extends the appointment duration.

If appointment scheduling program 200 determines pre-appointment testing results 124 do not include: results that are outside of normal ranges, abnormal, inconclusive results, positive test results for medical conditions and/or a developing health problem, then appointment scheduling program 200 calculates an underrun. Appointment scheduling program 200 shortens or maintains the duration of the appointment (e.g., removes or minimizes time for discussion of testing results) based corresponding times set by the service provider, standard times, crowd source history data 126, and/or by manual adjustment by the service provider for favorable results. If appointment scheduling program 200 determines pre-appointment testing results 124 include: results that are outside of normal ranges, inconclusive results, positive test results for medical conditions, and/or a developing health problem, then appointment scheduling program 200 determines an increase to the duration of the appointment time. Appointment scheduling program 200 determines the increase to the time duration of the appointment based on the identified results and corresponding times set by the service provider, standard times, crowd source history data 126 (e.g., includes record of time spent discussing test results from an identified comparison group), and/or by manual adjustment by the service provider (e.g., results are flagged for review by physician, and upon review alters the appointment time) to discuss the specified finding of pre-appointment testing results 124. For example, a physician may discuss manners of treatment that require additional time to discuss that would not otherwise be necessary.

In another embodiment, appointment scheduling program 200 determines changes to the appointment time based on one or more aforementioned embodiments (e.g., compounds schedule changes for pre-appointment test results and due to time changes associated with another appointment). For example, if appointment scheduling program 200 identifies a discrepancy and determines that the magnitude of the discrepancy is greater than the threshold, then appointment scheduling program 200 determines changes to appointment times due to the discrepancy caused by another appointment. Furthermore, if appointment scheduling program 200 also identifies pre-appointment testing results 124 and determines that pre-appointment testing results 124 include results that alter the duration of an appointment, then appointment scheduling program 200 determines additional changes to appointment times due to pre-appointment testing results 124. In one embodiment, appointment scheduling program 200 calculates the magnitude of the overrun or underrun. In another embodiment, appointment scheduling program 200 receives a magnitude of the overrun or underrun based on times set by the service provider, standard times, crowd source history data 126, and/or by manual adjustment by the service provider. Appointment scheduling program 200 determines a new start time of the appointment based on the magnitude of the overrun (i.e., adds the calculated or received overrun time to the start time) or the magnitude of the underrun (i.e., subtracts the calculated of received underrun from the start time). Appointment scheduling program 200 stores the changes to the appointment times in schedule 127. Appointment scheduling program 200 initiates generation of notification 128, upon updating schedule 127.

In some other embodiment, appointment scheduling program 200 does not determine changes to an appointment time. For example, if appointment scheduling program 200 does not does not identify a discrepancy or determines that the magnitude of the discrepancy is less than the threshold, then appointment scheduling program 200 does not determine changes to appointment times due to another appointment. Furthermore, if appointment scheduling program 200 does not identify pre-appointment testing results 124 or appointment scheduling program 200 determines that pre-appointment testing results 124 do not include results that would alter the duration of an appointment, then appointment scheduling program 200 does not determine changes to appointment times due to pre-appointment testing results 124. Therefore, as neither the discrepancy nor pre-appointment testing results 124 result in appointment scheduling program 200 altering the duration of an appointment, appointment scheduling program 200 does not determine changes to an appointment time.

In decision 224, appointment scheduling program 200 determines whether changes to schedule 127 occur. For example, appointment scheduling program 200 upon determining changes to schedule 127, initiates generation of notification 128, which indicates a change to schedule 127 occurs. If appointment scheduling program 200 determines that changes to schedule 127 occur (yes branch, decision 224), then appointment scheduling program 200 provides notification 128. If appointment scheduling program 200 determines that changes to schedule 127 do not occur (no branch, decision 224), then appointment scheduling program 200 completes.

In step 226, appointment scheduling program 200 provides notification 128 for appointment changes to affected clients and/or service providers. In one embodiment, appointment scheduling program 200 sends notification 128 as a text message and/or email to affected clients and/or the service provider for viewing on client device 110 and/or service provider device 150. In another embodiment, appointment scheduling program 200 provides notification 128 by automatically calling affected clients (e.g., calls client device 110, or utilizes contact information in client file 122 to place a phone call). In some other embodiment, appointment scheduling program 200 provides notification 128 as a summary of changes to the service provider through a text, e-mail, and/or an alert on service provider device 150 (e.g., multiple changes for multiple patients). Additionally, in some embodiments, appointment scheduling program 200 includes a confirmation request as part of notification 128 for the time change from the client (e.g., time of appointment changes to earlier than the suggested advance arrival time). If appointment scheduling program 200 receives a confirmation, appointment scheduling program 200 updates schedule 127 and completes. Alternatively, if appointment scheduling program 200 receives a rejection to the confirmation response, appointment scheduling program 200 maintains the originally scheduled time, and changes the excess time in schedule 127 to unassigned.

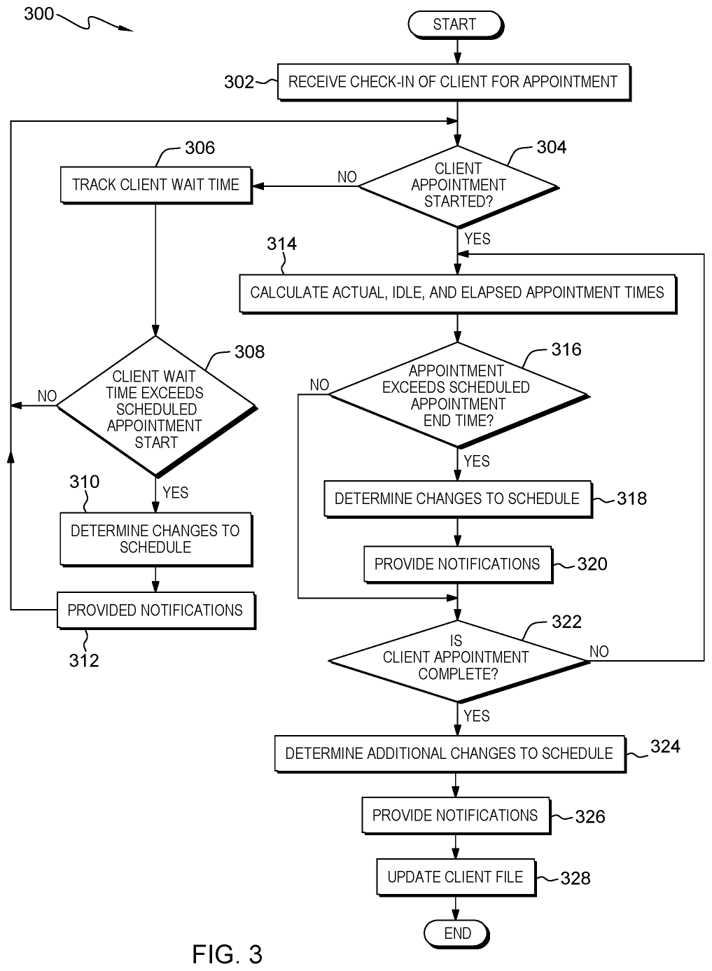

FIG. 3 is a flowchart depicting operational steps of appointment tracking program 300 for tracking an actual duration of an appointment for a client, and optimizing schedule 127 in real-time, in accordance with an embodiment of the present invention. In one embodiment, appointment tracking program 300 initiates as a background program and/or a function of an appointment scheduling application. In another embodiment, appointment tracking program 300 is a stand-alone program for tracking and optimizing schedule 127 in real time. In an embodiment, appointment scheduling program 200 initiates in response to a client checking in for an appointment.

In step 302, appointment tracking program 300 receives a check-in of the client for the appointment. In one embodiment, appointment tracking program 300 receive a manual check-in via appointment management client program 114A or appointment management client program 114B (e.g., selects to check-in via the application, personally interacts with a service provider employee and checks in, etc.). In another embodiment, appointment tracking program 300 receives an automatic check-in of the client from tracking device 160. For example, tracking device 160 determines the location of the client to be at the doctor's office, based on GPS information and/or by connecting to a service provider network, and checks-in the client. Additionally, in an embodiment, appointment tracking program 300 verifies the identity of the client by sending a request to the client to perform the check-in process or to confirm check-in for an identified appointment. In some embodiments, appointment tracking program 300 receives an advance check-in estimate based on an estimated time of arrival from tracking device 160. For example, the client authorized the service provider access to IoT device 140, which includes tracking device 160. Appointment tracking program 300 obtains a current location of the client and a rate of travel from tracking device 160. Appointment tracking program 300 calculates an estimated time of arrival based on the GPS information of the client and the address of the service provider. Appointment tracking program 300 determines whether the client will be early, on time, or late to the appointment based on the estimated time of arrival. Appointment tracking program 300 utilizes the information to automatically determine changes to schedule 127 in an effort to avoid incurring delays and prolonged wait time for other clients. At the time of check-in (i.e., client is present at the location of the scheduled service), appointment tracking program 300 records the actual time of arrival of the client.

In decision 304, appointment tracking program 300 determines whether the client appointment started. In one embodiment, appointment tracking program 300 monitors an instance of tracking device 160 provided by the service provider to the client and/or registered to the client (e.g., client authorizes tracking by appointment tracking program 300). Appointment tracking program 300 determines changes in the location of the client within the designated areas of the service provider. Appointment tracking program 300 determines the client appointment starts in response to detecting a change in location of tracking device 160 from a designated waiting area to a designated private active area. For example, a client receives tracking device 160 from the service provider upon check-in, and the location is within the waiting area of the service provider. The client is called, and moves to a private room. As the client passes a scanner, appointment tracking program 300 detects the passage of the client, and initiates the start of the client appointment. In another embodiment, appointment tracking program 300 receives a manual input via appointment management client program 114B that a client is being moved from the waiting room to a private room. For example, the service provider calls for the client, and moves the client from the waiting list to an active list. Conversely, appointment tracking program 300 determines the client appointment is not started by determining the client is located in the waiting area based on tracking device 160, or is not moved from the client waiting list (e.g., clients waiting to be seen) to the client active list (e.g., clients that are being seen by at least a member of the service provider group such as an assistant, nurse practitioner, nurse, physician's assistant, etc.).

If appointment tracking program 300 determines the client appointment started (decision 304, yes branch), then appointment tracking program 300 tracks the actual time of the appointment (step 314). If appointment tracking program 300 determines the client appointment has not started (decision 304, no branch), then appointment tracking program 300 tracks the client wait time (step 306).

In step 306, appointment tracking program 300 determines a client wait time. In some embodiments, appointment tracking program 300 calculates a client wait time as the difference between the current time and the scheduled appointment start time, which provides a positive or negative time difference. A negative time difference indicates the client is early for the appointment (e.g., appointment maintains a possibility that the appointment will start early or on time). A positive time difference indicates that the client is waiting past the scheduled appointment time (e.g., appointment will start late, incurs a delay). Appointment tracking program 300 stores the calculated client wait time for further utilization.

In decision 308, appointment tracking program 300 determines whether the client wait time exceeds the scheduled appointment start time. If appointment tracking program 300 determines the client wait time is a negative time difference, then appointment tracking program 300 determines the client wait time does not exceed the scheduled appointment start time (i.e., the client is not waiting for an appointment to start as a result of a delay associated with the service provider). Therefore, as an early arrival time does not guarantee an earlier start for a scheduled appointment, appointment tracking program 300 does not track the negative time difference as a wait time. If appointment tracking program 300 determines a positive time difference, then appointment tracking program 300 compares the arrival time of the client to the scheduled start time of the appointment. If appointment tracking program 300 determines the arrival time of the client is before the scheduled appointment time, then appointment tracking program 300 determines the wait time exceeds the scheduled appointment start time (i.e., the client is waiting for an appointment to start due to a delay associated with the service provider). Therefore, as the delay is due to the service provider rather than a late arrival of the client, appointment tracking program 300 tracks and stores the positive time difference as an overrun time (e.g., client wait time, delay). However, if appointment tracking program 300 determines the arrival time of the client is after the scheduled appointment time (e.g., client arrives late), then appointment tracking program 300 updates the scheduled start time for the scheduled appointment to at least the arrival time of the client. Appointment tracking program 300 recalculates the wait time as the difference between the current time and the updated scheduled appointment start time, which captures the actual wait time, rather than an artificially inflated wait time (e.g., client does not wait for an appointment when not present).

If appointment tracking program 300 determines the client wait time exceeds the scheduled appointment start time (decision 308, yes branch), then appointment tracking program 300 determines changes to schedule 127 (step 310). If appointment tracking program 300 determines the client wait time does not exceeds the scheduled appointment start time (decision 308, no branch), then appointment tracking program 300 determines whether the client appointment started (decision 304).

In step 310, appointment tracking program 300 determines changes to schedule 127. Appointment tracking program 300 identifies appointments within schedule 127 that are waiting to be seen (e.g., pending, in queue, etc.). In one embodiment, appointment tracking program 300 revises the start time of the waiting appointment by the overrun time and an additional minimum delay (e.g., standard five minutes, service provider entered delay). In another embodiment, appointment tracking program 300 revises the start time of the waiting appointment by the overrun time of another appointment and an estimated time of completion. For example, appointment tracking program 300 calculates a projected overrun of five minutes for the prior appointment. Additionally, appointment tracking program 300, based on set times by the service provider, determines the physician needs a minimum break between appointments of three minutes. Therefore, appointment tracking program 300 determines the waiting appointment will incur an additional delay of eight minutes. Appointment tracking program 300 revises the start time of the waiting appointment by eight minutes (e.g., calculates the start time as the current time plus eight minutes.). Appointment tracking program 300 calculates a revised end time by applying the duration of the appointment to the revised start time.

In another embodiment, appointment tracking program 300 identifies contingency buffers and/or service provider allocated times within schedule 127. Appointment tracking program 300 reallocates the contingency buffers and/or service provider allocated times that follow the waiting appointment, thereby minimizing future impacts to schedule 127. Appointment tracking program 300 determines whether additional time remains that is unable to be absorbed by the initial reallocation (i.e., determines whether the overrun is contained within the first contingency buffer associated with the first appointment and/or the waiting appointment that immediately follows the overrun). If appointment tracking program 300 determines additional time remains (e.g., partial delay is present), appointment tracking program 300 repeats one or more of the aforementioned embodiments until appointment tracking program 300 determines the delay is absorbed (e.g., remaining time delay is equal to zero, remaining time delay is equal or less than the threshold identified as acceptable for overlap and/or overbooking). In some other embodiment, appointment tracking program 300, identifies available appointments within schedule 127 for another service provider within the practice (e.g., mitigation plan, transfers client to an available service provider).

In step 312, appointment tracking program 300 provides notification 128. In one embodiment, appointment tracking program 300 automatically sends notification 128 as a text message and/or email to waiting clients, affected clients, and/or the service provider for viewing on client device 110 and/or service provider device 150. In another embodiment, appointment tracking program 300 provides notification 128 by automatically calling non-waiting affected clients and notifies the client of an impending delay to assist in avoiding a prolonged delay at the service provider. In some other embodiment, appointment tracking program 300 provides notification 128 as a visual notification to the client and/or service provider. For example, appointment tracking program 300 sends notification 128 to tracking device 160 provided to the client, which displays a message stating the anticipated new start time of the appointment. However, in the example, as the service provider is with a client, appointment tracking program 300 sends notification 128 as a visual notification, and illuminates a light in a patient room, thereby indicating a time overrun and impending changes to schedule 127.

In some other embodiments, appointment tracking program 300 provides mitigation plans to the client (e.g., reschedule appointment, switch to another service provider) within notification 128. For example, appointment tracking program 300 identifies an available appointment with another service provider within the practice. Appointment tracking program 300 notifies the client of an available option to switch the appointment to the available service provider in order to avoid incurring the projected delay. If appointment tracking program 300 determines the client consents to a mitigation plan, appointment tracking program 300 repeats one or more of the aforementioned embodiments in conjunction with the selected mitigation plan (e.g., minimizes additional changes with schedule 127.). If appointment tracking program 300 determines the client does not accept a mitigation plan or a mitigation plan is not available, then appointment tracking program 300 returns to decision 304.

In step 314, appointment tracking program 300 calculates actual, idle, and elapsed appointment times. Actual appointment time is the time a client spends in a designated private area (i.e., area identified for use by or for the client during an appointment) with a service provider. Idle appointment time is the time a client spends in the designated area without a service provider present (i.e., provides service provider feedback to make future improvements). Elapsed appointment time is an overall time that the client spends with and without a service provider present (e.g., combines actual and idle time, time difference between the start of the appointment and current time, total duration of an appointment, etc.). In one embodiment, appointment tracking program 300 utilizes timer functions (e.g., stopwatches) to track and record the elapsed, actual, and idle times (i.e., separate timer functions record time for each appointment time type). In another embodiment, appointment tracking program 300 records actual clock values and identifies the recorded value as a start and/or stop times for each appointment time type (i.e., elapsed, actual, and idle).

Appointment tracking program 300 determines the client appointment starts (decision 304, yes branch), and appointment tracking program 300 begins timer functions for elapsed and actual times. In an embodiment, appointment tracking program 300 records the current time as the start time, and initiates calculation of actual and elapsed appointment times. In an example, upon entering the designated private area, appointment tracking program 300 determines whether the client is alone based on tracking device 160 (i.e., detects presence of tracking device 160 associated with the service provider). If appointment tracking program 300 determines the client is not alone, then appointment tracking program 300 continues recording and calculating actual and elapsed appointment times. If appointment tracking program 300 determines the client is alone, appointment tracking program 300 stops the timer function for the actual appointment time and initiates the timer function for the idle appointment time and/or records the current time as a stop time for the actual appointment time and as a start time for the idle appointment time. Throughout the client appointment, multiple stops and starts of timer functions and/or records multiple start and stop times for actual and idle appointment times may occur. For each stop and start pairing, appointment tracking program 300 calculates and records the elapsed, actual, and/or idle appointment times as the difference between the identified start and stop times for each appointment type. If multiple stops and starts occur, appointment tracking program 300 combines the calculated time values for each appointment time type to determine overall times.

For example, at a doctor's office, a client enters an exam room at 1 P.M., and a staff member collects initial patient vitals (e.g., height, weight, blood pressure, temperature, etc.). Upon completion, the staff member exits at 1:10 P.M. (e.g., tracking device 160 is outside exam room, badge reader logs an exit from the room, etc.). Appointment tracking program 300 stops tracking the actual time and stores the actual time value of 10 minutes. Appointment tracking program 300 begins tracking the idle time at 1:10 P.M. (e.g., begins at the same time appointment tracking program 300 determines the staff member exits the room). At 1:15 P.M., appointment tracking program 300 determines the physician returns (e.g., identified by badge data), and resumes tracking of the actual time. Additionally, appointment tracking program 300 stops tracking the idle time and records the idle time as five minutes. Appointment tracking program 300 further determines the physician leaves the room at 1:30 P.M., and appointment tracking program 300 again stops tracking the actual time and resumes tracking the idle time. Appointment tracking program 300 determines an actual time between 1:15 P.M. and 1:30 P.M. to be fifteen minutes, and calculates the overall actual time to be twenty-five minutes. Additionally, appointment tracking program 300 determines the idle time to be five minutes and the elapsed appointment time is thirty minutes.

In decision 316, appointment tracking program 300 determines whether the appointment exceeds the scheduled appointment end time. Appointment tracking program 300 compares the current time with the scheduled appointment end time within schedule 127 to make a determination. For example, the current time is 1:16 P.M. and the scheduled appointment end time is 1:20 P.M. Appointment tracking program 300 determines that 1:16 P.M. is before the scheduled appointment end time, therefore, the appointment does not exceed the scheduled appointment end time. Conversely, if the current time is 1:26 P.M., then appointment tracking program 300 determines that 1:26 P.M. is after 1:20 P.M., and therefore, the appointment exceeds the scheduled appointment end time. Additionally, if appointment tracking program 300 determines the appointment exceeds the scheduled appointment end time, then appointment tracking program 300 calculates the magnitude of overrun as the difference between the current time and the schedule end time. Therefore, in continuing the example, appointment tracking program 300 calculates the overrun to be six minutes.

If appointment tracking program 300 determines the appointment exceeds the scheduled appointment end time (decision 316, yes branch), then appointment tracking program 300 determines changes to schedule 127 (step 318). If appointment tracking program 300 determines the appointment does not exceed the scheduled appointment end time (decision 316, no branch), then appointment tracking program 300 determines whether the client appointment is complete (decision 322).

In step 318, appointment tracking program 300 determines changes to schedule 127. Appointment tracking program 300 identifies appointments within schedule 127 that are waiting to be seen and/or that occur after the appointment. In one embodiment, appointment tracking program 300 revises the start time of the waiting appointments by the overrun time or the overrun time with an additional minimum delay. In another embodiment, appointment tracking program 300 revises the start time of the waiting appointment by the overrun time and an estimated time of completion. Appointment tracking program 300 calculates a revised end time by applying the duration of the scheduled appointment to the revised start time. In another embodiment, appointment tracking program 300 identifies contingency buffers and/or service provider allocated times (e.g., service provider is not scheduled with a client) within schedule 127. Appointment tracking program 300 reallocates the contingency buffers and/or service provider allocated times that follow the waiting appointment to minimize impacts to schedule 127. Appointment tracking program 300 determines whether additional time remains that is unable to be absorbed by the reallocation. If appointment tracking program 300 determines additional time remains (e.g., partial delay is present), appointment tracking program 300 revises the start time of the waiting appointments by the overrun time and/or an additional minimum delay or an estimated time of completion, until appointment tracking program 300 determines the incurred delay is absorbed (e.g., remaining time delay is equal to zero, remaining time delay is equal or less than the threshold).

In some other embodiment, appointment tracking program 300, identifies available appointments within schedule 127 for another service provider within the practice (e.g., allows transfer of a client). In one embodiment appointment tracking program 300 automatically switches the client to the available appointment within schedule 127 to mitigate impacts to schedule 127 and to the client. In another embodiment, appointment tracking program 300 identifies service provider preferences and/or restrictions within client file 122. Appointment tracking program 300 identifies available appointment times in schedule 127 based on the preferences and/or restrictions prior to automatically switching the client. If appointment tracking program 300 identifies available appointment times that match the preferences in client file 122, then appointment tracking program 300 automatically switches the client to the available appointment time. However, if appointment tracking program 300 identifies available appointment times that match the preferences in client file 122, then appointment tracking program 300 utilizes one of more of the aforementioned embodiments to determine changes to schedule 127.

For example, a first client is currently in an appointment with Dr. Matt, and a second client is waiting to be seen by Dr. Matt. The appointment for the first client currently exceeds the scheduled appointment time by ten minutes and is projected to continue for a minimum of ten additional minutes. Therefore, the second client incurs a minimum 20-minute wait to be seen past the start of the scheduled appointment time. However, Dr. Matt is part of a medical practice, that includes Dr. Collin and Dr. Shawn. Appointment tracking program 300 access client file 122 for the second client, and identifies Dr. Collin as an accepted alternate service provider, but Dr. Shawn is not listed as an accepted alternate service provider. Appointment tracking program 300 identifies available appointment times for Dr. Collin within schedule 127 for the current time/and or times that would allow the second client to be seen sooner than the estimated start time for the existing service provider. Appointment tracking program 300 does not identify available appointment times with Dr. Shawn as the preferences within client file 122 indicate Dr. Shawn is restricted (e.g., client does not want to be seen by Dr. Shawn). Upon appointment tracking program 300 identifying an available appointment with Dr. Collin for the current time, appointment tracking program 300 automatically switches the second client to the available appointment within schedule 127, and records the change in schedule 127.

In some other embodiment, appointment tracking program 300 performs one or more of the aforementioned embodiments to determine changes to schedule 127. Additionally, while only a single schedule change for a single patient is described, appointment tracking program 300 repeats one or more of the aforementioned embodiments for each client that is affected due to the appointment time exceeding the end schedules end time (i.e., overrun is not localized to just a single appointment and can spread to multiple appointments).

In step 320, appointment tracking program 300 provides notifications 128. In one embodiment, appointment tracking program 300 automatically sends notification 128 as a text message and/or email to waiting clients, affected clients, and/or the service provider for viewing on client device 110 and/or service provider device 150. In another embodiment, appointment tracking program 300 provides notification 128 by automatically calling non-waiting affected clients and notifies the client of an impending delay to assist in avoiding a prolonged delay at the service provider. In some other embodiment, appointment tracking program 300 provides notification 128 as a visual notification to the client and/or service provider.

In decision 322, appointment tracking program 300 determines whether the client appointment is complete. In one embodiment, appointment tracking program 300 determines the client is no longer in the designated private area based on tracking device 160. In another embodiment, appointment tracking program 300 receives a notification from the service provider that the appointment is complete. In some other embodiment, appointment tracking program 300 determines the service provider closes out client file 122 (e.g., finalizes a bill), which indicates the appointment is complete. In yet another embodiment, appointment tracking program 300 identifies a payment to the account associated with client file 122 is made. In yet some other embodiments, appointment tracking program 300 identifies another appointment is made within schedule 127 for the client. In yet another additional embodiment, appointment tracking program 300, receives a notification that the designated private area is marked as empty and/or for cleaning. In yet some other additional embodiments, appointment tracking program 300 utilizes one or more of the aforementioned embodiments, to determine that the client appointment is complete. If the converse of one or more of the aforementioned embodiments occurs, then appointment tracking program 300 determines the client appointment is not complete and returns to step 314. If appointment tracking program 300 determines the client appointment is complete, then appointment tracking program 300 finalizes the appointment times by stopping the timer functions and/or recording the current time as the actual end time of the client appointment. Appointment tracking program 300 calculates a final value for the actual, idle, and elapsed appointment times based on the end time.

If appointment tracking program 300 determines the client appointment is complete (decision 322, yes branch), then appointment tracking program 300 determines additional changes to schedule 127 (step 324). If appointment tracking program 300 determines the client appointment is not complete (decision 322, no branch), then appointment tracking program 300 tracks the actual time of the appointment (step 314).

In step 324, appointment tracking program 300 determines additional changes to schedule 127. Appointment tracking program 300 determines whether the appointment ended on-time, early, or late. Appointment tracking program 300 compares the recorded end time of the appointment with the scheduled end time of the appointment. If appointment tracking program 300 determines the actual end time is the same as the current time, then appointment tracking program 300 determines the appointment ended on-time and no additional changes to schedule 127 are necessary.

If appointment tracking program 300 determines the actual end time is less than the scheduled end time of the appointment, then appointment tracking program 300 determines the appointment ended early. Appointment tracking program 300 calculates the magnitude of underrun as the difference between the actual end time and the scheduled end time, in which the difference is a negative value (e.g., indicates an underrun). In one embodiment, appointment tracking program 300 determines the magnitude of the underrun is negligible (e.g., underrun is five minutes or less.) and therefore, no additional changes to schedule 127 are necessary. However, if appointment tracking program 300 determined the underrun is not negligible (e.g., underrun is greater than five minutes), then appointment tracking program 300 determines changes to schedule 127 that move subsequent appointments to earlier times.

Appointment tracking program 300 identifies appointments within schedule 127 that are waiting to be seen and/or that occur after the appointment. In one embodiment, appointment tracking program 300 revises the start time of the waiting appointments by the underrun time (e.g., moves the start time ahead by the amount of the underrun). Appointment tracking program 300 calculates a revised end time by applying the duration of the scheduled appointment to the revised start time. In another embodiment, appointment tracking program 300 identifies contingency buffers and/or service provider allocated times within schedule 127 and extends the allocated time by the magnitude of the underrun (e.g., allows more preparation time, recovers time lost to a prior overrun, etc.). In some other embodiment, appointment tracking program 300 adds another appointment to schedule 127 (e.g., combination of the underrun, time saved by the movement of subsequent appointments, and/or contingency buffers equals a new appointment time).

If appointment tracking program 300 determines the actual end time is greater than the scheduled end time of the appointment, then appointment tracking program 300 determines the appointment ended late. Appointment tracking program 300 calculates the magnitude of overrun as the difference between the actual end time and the scheduled end time, in which the difference is a positive value (e.g., indicates an overrun). In one embodiment, appointment tracking program 300 determines the magnitude of the overrun is negligible (e.g., underrun is five minutes of less.) and therefore, no additional changes to schedule 127 are necessary. However, if appointment tracking program 300 determined the overrun is not negligible (e.g., underrun is greater than five minutes), then appointment tracking program 300 determines changes to schedule 127.

Appointment tracking program 300 identifies appointments within schedule 127 that occur after the appointment waiting to be seen (i.e., the appointment waiting is already onsite and is next in line to be called). In one embodiment, appointment tracking program 300 revises the start time of the appointments by the overrun time. Appointment tracking program 300 calculates a revised end time by applying the duration of the scheduled appointment to the revised start time. In another embodiment, appointment tracking program 300 identifies contingency buffers and/or service provider allocated times within schedule 127. Appointment tracking program 300 reallocates the contingency buffers and/or service provider allocated times that follow the waiting appointment, thereby minimizing future impacts to schedule 127. Appointment tracking program 300 determines whether additional time remains that is unable to be absorbed by the reallocation. If appointment tracking program 300 determines additional time remains (e.g., partial delay is present), appointment tracking program 300 revises the start time of additional appointments in schedule 127 by the overrun time, until appointment tracking program 300 determines the incurred delay due to the overrun is absorbed (e.g., remaining time delay is equal to zero).

In some other embodiments, appointment tracking program 300, identifies available appointments within schedule 127 for another service provider within the practice. In one embodiment appointment tracking program 300 automatically switches the client to the available appointment within schedule 127 to mitigate further impacts to schedule 127 and to the client. For example, an overall overrun is equal to at least half of the length of an appointment. By appointment tracking program 300 rescheduling the appointment to an available time slot with another practitioner, appointment tracking program 300: eliminates the overrun for the service provider, eliminates further impacts to schedule 127 and clients, reduces the number of changes to schedule 127, and reduces the number of notifications to be sent thereby improving computing times and efficiency. In another embodiment, appointment tracking program 300 identifies service provider preferences and/or restrictions within client file 122. Appointment tracking program 300 identifies available appointment times in schedule 127 based on the preferences and/or restrictions and automatically switches the client.

In step 326, appointment tracking program 300 provides notifications 128. In one embodiment, appointment tracking program 300 automatically sends notification 128 as a text message and/or email to affected clients and/or the service provider for viewing on client device 110 and/or service provider device 150. In another embodiment, appointment tracking program 300 provides notification 128 by automatically calling non-waiting affected clients and notifies the client of an impending delay (i.e., assists in avoiding a prolonged delay at the service provider) and/or an earlier start time (i.e., allows the client to arrive early and take advantage of the known free time, thereby avoiding delays and/or to speeds up the appointment process). In some other embodiment, appointment tracking program 300 provides notification 128 as a visual notification to the client and/or service provider that indicates a schedule overrun, a schedule underrun, and/or changes to schedule 127 for viewing.

In step 328, appointment tracking program 300 updates client file 122. Appointment tracking program 300 records the actual time, idle time, and elapsed time of the appointment within appointment history data 123. In one embodiment, appointment tracking program 300 updates client file 122 with service provider notes regarding the client, suggested appointment durations (e.g., add more time, decrease appointment time, keep appointment time the same, an amount of a time change, etc.). Appointment tracking program 300 converts the data associated with the completed appointment to appointment history data 123. For example, appointment tracking program 300 adds pre-appointment testing results 124 to appointment history data 123 for utilization by appointment scheduling program 200 for subsequent scheduled appointments. Upon completion, the updated information in client file 122 is available for utilization to schedule future appointments. Additionally, in some embodiments at completion, appointment tracking program 300 provides the service provider an analysis of the client's visit that identifies areas for improvement (e.g., notes excessive idle times, prolonged wait times, the number of appointment time changes, etc.) to raise customer satisfaction and provided services.

FIG. 4 depicts a block diagram of components of server 120 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Server 120 includes communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM) 414. In general, memory 406 can include any suitable volatile or non-volatile computer readable storage media. Cache 416 is a fast memory that enhances the performance of computer processor(s) 404 by holding recently accessed data, and data near accessed data, from memory 406.

Appointment management program 121, appointment scheduling program 200, appointment tracking program 300, client file 122, appointment history data 123, pre-appointment testing results 124, client information 125, crowd source history data 126, schedule 127, and notification 128 may be stored in persistent storage 408 and in memory 406 for execution and/or access by one or more of the respective computer processor(s) 404 via cache 416. In an embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. User interface 112A, user interface 112B, user interface 142, IoT Data 144, appointment management client program 114A, appointment management client program 114B, appointment management program 121, appointment scheduling program 200, appointment tracking program 300, client file 122, appointment history data 123, pre-appointment testing results 124, client information 125, crowd source history data 126, schedule 127, and notification 128 may be downloaded to persistent storage 408 through communications unit 410.

I/O interface(s) 412 allows for input and output of data with other devices that may be connected to server 120. For example, I/O interface(s) 412 may provide a connection to external device(s) 418, such as a keyboard, a keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., user interface 112A, user interface 112B, user interface 142, IoT Data 144, appointment management client program 114A, appointment management client program 114B, appointment management program 121, appointment scheduling program 200, appointment tracking program 300, client file 122, appointment history data 123, pre-appointment testing results 124, client information 125, crowd source history data 126, schedule 127, and notification 128, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for managing appointments the method comprising:
receiving, by one or more computer processors, a request for an appointment from a user;
identifying, by one or more computer processors, a history data for a type of appointment, wherein the history data provides information regarding one or more prior appointments associated with the user;
receiving, by one or more computer processors, IoT data prior to the scheduled appointment associated with the user;
determining, by one or more computer processors, one or more available appointments within a schedule based on the received request, the identified history data, and the received IoT data; and
scheduling, by one or more computer processors, an appointment based on one of the one or more determined available appointments.

2. The method of claim 1, further comprising:
determining, by one or more computer processors, that the received IoT data does not add additional time to the scheduled appointment;
calculating, by one or more computer processors, an underrun; and
determining, by one or more computer processors, a change to the scheduled appointment for the user based on the calculated underrun.

3. The method of claim 1, further comprising:
determining, by one or more computer processors, that the received IoT data adds additional time to the scheduled appointment;
calculating, by one or more computer processors, an overrun; and
determining, by one or more computer processors, a change to the scheduled appointment for the user based on the calculated overrun.

4. The method of claim 1, wherein the history data comprises: a type of service scheduled, an actual duration, an appointment date and time, and a prior received IoT data associated with the user.

5. The method of claim 1, further comprises:
determining, by one or more computer processors, whether the user is a client;
responsive to determining that the user is not a client, creating, by one or more computer processors, a client file for the user within a client database;
identifying, by one or more computer processors, a comparison group based on the received request, wherein the comparison group is a group of individuals that share one or more demographic variables with the user, which serves as a basis for a comparison between the user and the group; and
retrieving, by one or more computer processors, the history data for the user based on the identified comparison group.

6. The method of claim 1 further comprises:
determining, by one or more computer processors, that an appointment for the user starts;
tracking, by one or more computer processors, a duration of the started appointment;
updating, by one or more computer processors, one or more appointments based in part on the tracked duration of the started appointment; and
storing, by one or more computer processors, the tracked duration of the started appointment for the user within the history data.

7. The method of claim 1, wherein the received IoT data provides one or more of collected facts and statistics associated with the user and testing that is ordered prior to the scheduled appointment.

8. The method of claim 1, further comprises;
identifying, by one or more computer processors, a change to the scheduled appointment;
identifying, by one or more computer processors, one or more appointments that are impacted by the identified change to the scheduled appointment;
determining, by one or more computer processors, changes to the identified one or more appointments;
updating, by one or more computer processors, the identified one or more appointments based on the determined changes; and
providing, by one or more computer processors, one or more notifications for the updated one or more appointments.

9. A computer program product for managing appointments the computer program product comprising:
one or more computer readable storage media and program instructions stored on the one or more computer readable storage media, the program instructions comprising:
program instructions to receive a request for an appointment from a user;
program instructions to identifying a history data for a type of appointment, wherein the history data provides information regarding one or more prior appointments associated with the user;
program instructions to receive IoT data prior to the scheduled appointment associated with the user;
program instructions to determine one or more available appointments within a schedule based on the received request, the identified history data, and the received IoT data; and
program instructions to schedule an appointment based on one of the one or more determined available appointments.

10. The computer program product of claim 9, further comprising program instructions, stored on the one or more computer readable storage media, to:
determine that the received IoT data does not add additional time to the scheduled appointment;
calculate an underrun; and
determine a change to the scheduled appointment for the user based on the calculated underrun.

11. The computer program product of claim 9, further comprising program instructions, stored on the one or more computer readable storage media, to:
determine that the received IoT data adds additional time to the scheduled appointment;
calculate an overrun; and
determine a change to the scheduled appointment for the user based on the calculated overrun.

12. The computer program product of claim 9, wherein the history data comprises: a type of service scheduled, an actual duration, an appointment date and time, and a prior received IoT data associated with the user.

13. The computer program product of claim 9, further comprises program instructions, stored on the one or more computer readable storage media, to:
determine whether the user is a client;
responsive to determining that the user is not a client, create a client file for the user within a client database;
identify a comparison group based on the received request, wherein the comparison group is a group of individuals that share one or more demographic variables with the user, which serves as a basis for a comparison between the user and the group; and
retrieve the history data for the user based on the identified comparison group.

14. The computer program product of claim 9 further comprises program instructions, stored on the one or more computer readable storage media, to:
determine that an appointment for the user starts;
track a duration of the started appointment;
update one or more appointments based in part on the tracked duration of the started appointment; and
store the tracked duration of the started appointment for the user within the history data.

15. The computer program product of claim 9, wherein the received IoT data provides one or more of collected facts and statistics associated with the user and testing that is ordered prior to the scheduled appointment.

16. The computer program product of claim 9, further comprises program instructions, stored on the one or more computer readable storage media, to;
identify a change to the scheduled appointment;
identify one or more appointments that are impacted by the identified change to the scheduled appointment;
determine changes to the identified one or more appointments;
update the identified one or more appointments based on the determined changes; and
provide one or more notifications for the updated one or more appointments.

17. A computer system for managing appointments the computer system comprising:
one or more computer processors, one or more computer readable storage media, and program instructions stored on the computer readable storage media for execution by at least one of the one or more processors, the program instructions comprising:
program instructions to receive a request for an appointment from a user;
program instructions to identifying a history data for a type of appointment, wherein the history data provides information regarding one or more prior appointments associated with the user;
program instructions to receive IoT data prior to the scheduled appointment associated with the user;
program instructions to determine one or more available appointments within a schedule based on the received request, the identified history data, and the received IoT data; and
program instructions to schedule an appointment based on one of the one or more determined available appointments.

18. The computer system of claim 17, further comprising program instructions, stored on the one or more computer readable storage media, to:
determine that the received IoT data adds additional time to the scheduled appointment;
calculate an overrun; and
determine a change to the scheduled appointment for the user based on the calculated overrun.

19. The computer system of claim 17, further comprises program instructions, stored on the one or more computer readable storage media, to:
determine whether the user is a client;
responsive to determining that the user is not a client, create a client file for the user within a client database;
identify a comparison group based on the received request, wherein the comparison group is a group of individuals that share one or more demographic variables with the user, which serves as a basis for a comparison between the user and the group; and
retrieve the history data for the user based on the identified comparison group.

20. The computer system of claim 17 further comprises program instructions, stored on the one or more computer readable storage media, to:
determine that an appointment for the user starts;
track a duration of the started appointment;
update one or more appointments based in part on the tracked duration of the started appointment; and
store the tracked duration of the started appointment for the user within the history data.
